(19) United States
(12) Patent Application Publication
(10) Pub. No.: US 2022/0011174 A1
(43) Pub. Date: Jan. 13, 2022

(54) TEMPERATURE MEASURING METHOD OF DISTRIBUTED MULTI-SECTION OPTICAL FIBERS, SYSTEM AND STORAGE MEDIUM

(71) Applicant: Guoxing Huijin Shenzhen Technology Co., Ltd., Shenzhen (CN)

(72) Inventors: Zhihua GE, Shenzhen (CN); Shuai GUAN, Shenzhen (CN); Wuhua ZHOU, Shenzhen (CN); Yuehua CHEN, Shenzhen (CN)

(21) Appl. No.: 17/140,153

(22) Filed: Jan. 4, 2021

(30) Foreign Application Priority Data
Jul. 9, 2020 (CN) 202010657178.9

(51) Int. Cl. G01K 11/32; G01K 15/00

(52) U.S. Cl. CPC G01K 11/32; G01K 15/005

(57) ABSTRACT

A temperature measuring method of distributed multi-section optical fibers, a system and a storage medium are provided. The method includes the following steps: obtaining data of original stokes and anti-stokes signals in a while optical fiber; distinguishing segments of a high-temperature and ordinary optical fibers according to a discontinuous point of signal data; performing interpolation calculation on the data of the segments of the high-temperature and ordinary optical fibers, respectively, according to their respective corresponding group refractive indexes, to align the data of the stokes and anti-stokes signals; according to the data of the aligned stokes and anti-stokes signals, respectively calculating temperature data of the high-temperature and ordinary optical fibers, respectively obtaining calibration parameters of the high-temperature and ordinary optical fibers; generating a final temperature according to temperature data of the high-temperature and ordinary optical fibers and their corresponding calibration parameters.

### BACKGROUND

### 1. Technical Field

The present disclosure generally relates to optical fiber sensing technologies, field, and especially relates to a temperature measuring method of distributed multi-section optical fibers, a system and a storage medium.

### 2. Description of Related Art

Oil and gas well temperature profile is important data for analyzing bottom hole productivity distribution, a temperature measurement system of distributed optical fibers can be configured to collect temperature profile of the whole oil and gas well through an optical fiber. However, for some underground geological conditions with very high temperatures, ordinary optical fibers working at low temperatures can't be worked for a long time. In order to adapt to high temperature environments in conventional technologies, the ordinary optical fiber is replaced by a high-temperature optical fiber which can withstand high temperature environments to ensure normal operation of equipments. However, the high-temperature optical fiber is very expensive, if the high-temperature optical fiber is used as all of the sensing optical fibers of the temperature measuring system with distributed optical fibers, the system is very expensive. The cost of the temperature measuring system can be reduced if the sensing optical fiber is formed by the ordinary optical fiber and the high-temperature optical fiber interlaced to be connected with each other, with the high-temperature optical fiber being placed under the well and the ordinary optical fiber being placed on the well. However, because materials of the high-temperature optical fiber and the ordinary optical fiber are different, their calibration parameters are different under the same temperature environment. If a kind of optical fiber calibration parameters is used to configure a length of all sensing optical fibers in the system, temperature data measured on other kinds of sensing optical fibers is deviated, thus affecting precision of temperature measurement for the temperature measuring system of distributed optical fibers.

Therefore, the conventional technology can be needed to be improved.

### SUMMARY

The technical problems to be solved: in view of the shortcomings of the related art, the present disclosure provides to a temperature measuring method of distributed multi-section optical fibers, a system and a storage medium, which can not only reduce costs of the temperature measuring system of distributed multi-section optical fibers under high temperature environments, but also eliminate measurement deviation between high-temperature optical fibers and ordinary optical fibers to ensure measurement accuracy of the temperature measuring system of distributed multi-section optical fibers.

To achieve the above purposes, the following technical scheme is adopted:

a temperature measuring method of distributed multi-section optical fibers is applied to a temperature measuring system of distributed multi-section optical fibers, the temperature measuring system including a distributed optical fiber thermometer and an optical fiber with multiple segments, the optical fiber with multiple segments divided into at least one high-temperature optical fiber and at least one ordinary optical fiber interlaced connected with the at least one high-temperature optical fiber;

wherein, the temperature measuring method, of distributed multi-section optical fibers includes the following steps:

S10, obtaining data of original stokes signals and data of anti-stokes signals in a while optical fiber;

S20, distinguishing data of a segment of a high-temperature optical fiber and data of a segment of an ordinary optical fiber according to a discontinuous point of signal data;

S30, performing interpolation calculation on the data of the segment of the high-temperature optical fiber and the data of the segment of the ordinary optical fiber, respectively, according to their respective corresponding group refractive indexes, to align the data of the stokes signals with the data of the anti-stokes signal in distance;

S40, according to the data of the aligned stokes and anti-stokes signals, performing temperature data calculation on the data of the segment of the high-temperature optical fiber and the data of the segment of the ordinary optical fiber, respectively;

S50, separately connecting the segment of the ordinary optical fiber and the segment of the high-temperature optical fiber with a distributed fiber thermometer and a high-an-low temperature controller, so as to obtain calibration parameters of the ordinary optical fiber and the high-temperature optical fiber, respectively; and

S60, generating a final temperature according to temperature data of the segment of the high-temperature optical fiber and the segment of the temperature data of the ordinary optical fiber, and their corresponding calibration parameters.

Wherein the interpolation calculation includes the following steps:

S301, according to a sampling distance, a sampling frequency and a group refractive index, calculating a position point with the nearest distance and the highest correlation that data of original signals corresponding to data of each interpolation signal, according to the formula:

$$X = \frac{D * Ng}{C} * F {s}_{;}$$

wherein X is a position point with the highest correlation; D is a sampling distance; Ng is a group refractive index of optical fibers; C is a velocity of light in a vacuum; Fs is a sampling frequency;

S302, taking the position point with the highest correlation as a center, performing weighted interpolation on each N points with left and right of the center according to distances far and near to obtain a corresponding value of signal data after being interpolated.

Wherein the calibration parameters include a temperature proportional coefficient adjustment parameter A and an offset compensation parameter B obtained under a temperature difference between a high temperature and a low temperature set in the high-and-low temperature controller for each optical fiber.

Wherein the final temperature is generated by a formula below: T=(A*R+B)−273.15; wherein T is a final temperature; R is the temperature data calculated in the step S40, and the temperature data is a ratio of the data of the anti-stokes signal to the data of the stokes signal.

A system according to an embodiment of the present disclosure includes a memory, a processor and computer programs stored in the memory and performed by the processor to implement the temperature measuring method above mentioned.

Wherein the system further includes a distributed optical fiber thermometer and an optical fiber with multiple segments, the optical fiber with multiple segments is divided into at least one high-temperature optical fiber and at least one ordinary optical fiber interlaced connected with the at least one high-temperature optical fiber, the distributed optical fiber thermometer including a pair of ports respectively connected to corresponding ends of the two ordinary optical fibers, the other ends of the two ordinary optical fibers respectively connected with the high-temperature optical fiber.

Wherein the ordinary optical fiber is connected with the high-temperature optical fiber by a welding connection way.

A computer readable storage medium according to an embodiment of the present disclosure is configured to store computer programs, the computer programs performed by a processor to implement the temperature measuring method above mentioned.

The temperature measuring method of distributed multi-section optical fibers of the present disclosure is configured to divide an optical fiber into at least one high-temperature optical fiber and at least one ordinary optical fiber interlaced to connect with each other, distinguish data of a segment of a high-temperature optical fiber and data of a segment of an ordinary optical fiber during temperature measurement, and perform interpolation calculation on the data of the segment of the high-temperature optical fiber and the data of the segment of the ordinary optical fiber, respectively, according to their respective corresponding group refractive indexes, to align the data of the stokes signals with the data of the anti-stokes signal in distance at each sampling moment, and generate a final temperature by combining different calibration parameters of the high-temperature optical fiber and the ordinary optical fiber, respectively. In this way, the present disclosure can not only reduce costs of the temperature measuring system of distributed multi-section optical fibers under high temperature environments, but also eliminate measurement deviation between high-temperature optical fibers and ordinary optical fibers to ensure measurement accuracy of the temperature measuring system of distributed multi-section optical fibers.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. Obviously, the drawings described below are some embodiments of the present disclosure, for one of ordinary skill in the related art, other drawings can be obtained according to the drawings below on the premise of no creative work.

FIG. 1 is a schematic diagram of an application system of a temperature measuring method of distributed multi-section optical fibers of the present disclosure.

FIG. 2 is a flowchart of the temperature measuring method of distributed multi-section optical fibers in accordance with an embodiment of the present disclosure.

FIG. 3 is a schematic diagram of a plurality of multi-section optical fibers of the present disclosure.

FIG. 4 is a schematic diagram of data of original stokes signals of an ordinary optical fiber and a high-temperature optical fiber of the present disclosure.

FIG. 5 is a timing alignment schematic diagram of sampled signals of the present disclosure.

FIG. 6 is an un-alignment schematic diagram on distances of the sampled signals of the present disclosure.

FIG. 7 is an un-alignment schematic diagram on distances of the sampling signals between the ordinary optical fiber and the high-temperature optical fiber of the present disclosure.

FIG. 8 is a schematic diagram of unequal distances between adjacent signals of the ordinary optical fiber and the high-temperature optical fiber of the present disclosure.

FIG. 9 is a flowchart of a data interpolation calculation process of a segment of the high-temperature optical fiber and a segment of the ordinary optical fiber section of the present disclosure.

FIG. 10 is a schematic diagram of finding a position point with the highest correlation in the interpolation calculation process of the present disclosure.

FIG. 11 is a schematic diagram of calculating a value of inverse distance weighted interpolation by the interpolation calculation process of the present disclosure.

FIG. 12 is a distance alignment schematic diagram of data of the ordinary and high-temperature optical fibers after being performed interpolation calculation of the present disclosure.

FIG. 13 is a schematic diagram of obtaining calibration parameters of the ordinary optical fiber of the present disclosure.

FIG. 14 is a schematic diagram of obtaining calibration parameters of the high-temperature optical fiber of the present disclosure.

FIG. 15 is a schematic diagram of a final temperature curve of the multi-section optical fiber before being performed calibration of the present disclosure.

FIG. 16 is a schematic diagram of a final temperature curve of the multi-section optical fiber after being performed calibration of the present disclosure.

The element labels according to the exemplary embodiment of the present disclosure shown as below:

system 100, thermometer 1, port 11, 12, optical fiber 2, high-temperature optical fiber 21, ordinary optical fiber 22, temperature controller 3.

### DETAILED DESCRIPTION

Reference will now be made in, detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described embodiment of the present disclosure, all other embodiments obtained by one of ordinary skill in the related art on the premise of no creative work are within the protection scope of the present disclosure.

A temperature measuring method of distributed multi-section optical fibers according to an embodiment of the present disclosure is applied to a temperature measuring system of distributed multi-section optical fibers 100. The temperature measuring system 100 includes a distributed optical fiber thermometer 1 and an optical fiber with multiple segments 2. The distributed optical fiber thermometer 1 includes a laser transmitter, an optical coupler, a photoelectric conversion amplification unit and a data acquisition and processing unit, and is configured to connect to a computer to complete to be performed data processing and data display, or can be directly integrated with a data processing and display unit.

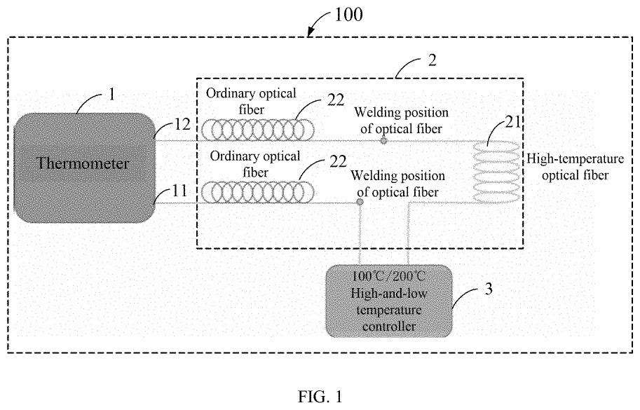

The optical fiber with multiple segments 2 is divided into at least one high-temperature optical fiber 21 and at least one ordinary optical fiber 22 interlaced to be connected with the at least one high-temperature optical fiber 21. The distributed optical fiber thermometer 1 includes at least one port 11 connected with one end of the ordinary optical fiber 22. The system further includes a temperature controller 3 that is a high and low temperature control box, which is configured to provide a high temperature and a low temperature with a difference therebetween for optical fibers. The distributed optical fiber thermometer 1 can be used for a single-port measurement, or it can be used for a dual-port measurement by setting the ports 11 and 12 as shown in FIG. 1.

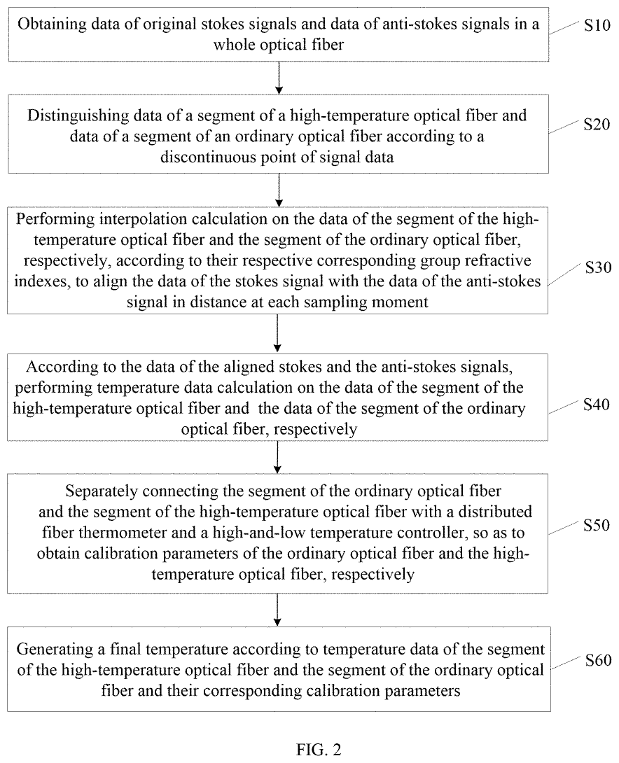

FIG. 2 illustrates a flowchart of the temperature measuring method of distributed multi-section optical fibers in accordance with an embodiment of the present disclosure. The method includes the following steps:

S10, obtaining data of original stokes signals and data of anti-stokes signals in a while optical fiber.

That is, obtaining the data of stokes signals and the data of the anti-stokes signals that are backscattered in the high-temperature optical fiber and the ordinary optical fiber. The data arc intensity values of stokes waves and anti-stokes waves scattered at a certain position (displacement).

S20, distinguishing data of a segment of a high-temperature optical fiber and data of a segment of an ordinary optical fiber according to a discontinuous point of signal data.

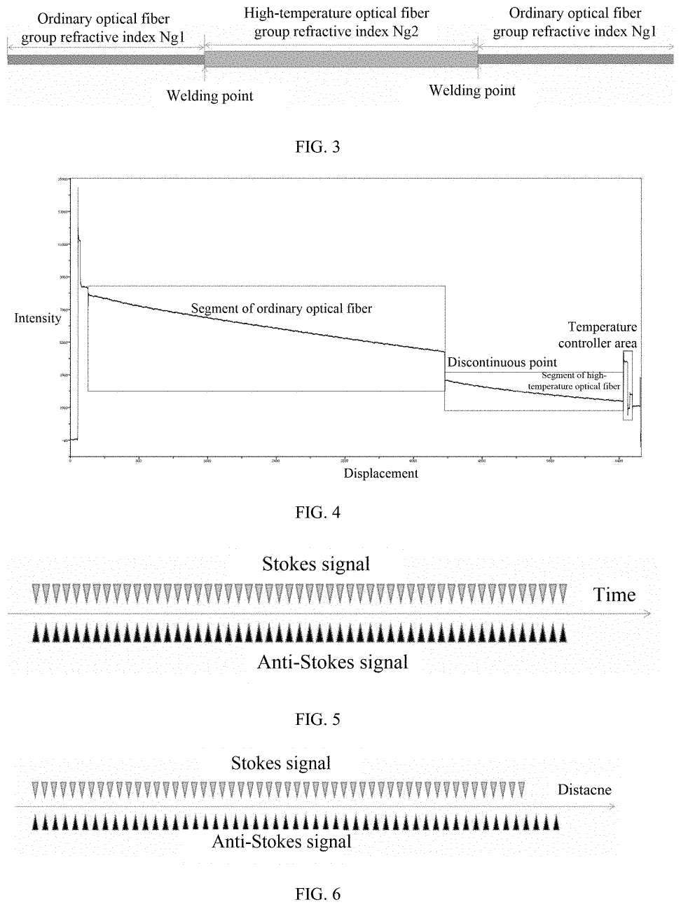

Properties of the high-temperature optical fiber and the ordinary optical fiber are different, so that their group refractive indexes are different. As shown in FIG. 3, a welding connection is formed between the ordinary optical fiber and the high-temperature optical fiber in the embodiment of the present disclosure. The group refractive index of the ordinary optical fiber is Ng1, and the group refractive index of the high-temperature optical fiber is Ng2 Due to different group refractive indexes, that is, Ng1 is not equal to Ng2, data collected by the ordinary optical fiber and the high-temperature optical fiber are inconsistent at their connection position, that is, the intensity value of refracted light at the welding position of the ordinary optical fiber and the high-temperature optical fiber is discontinuous and is jumped at the welding position. Referring to FIG. 4, the intensity of stokes light waves backscattered between the ordinary optical fiber and the high-temperature optical fiber has an obvious step at the connection of the two optical fibers, that is, a discontinuous point. With the discontinuous transition point as a boundary between the ordinary optical fiber and the high-temperature optical fiber, combining a displacement of light wave on the fibers, a segment of the ordinary optical fiber and a segment of the high-temperature optical fiber can be distinguished.

A purpose of distinguishing the segment of the ordinary optical fiber and the segment of the high-temperature optical fiber is to separately calculate their respective data, so as to ensure accuracy of temperature measurements.

S30, performing interpolation calculation on the data of the segment of the high-temperature optical fiber and the data of the segment of the ordinary optical fiber, respectively, according to their respective corresponding group refractive indexes, to align the data of the stokes signals with the data of the anti-stokes signal in distance at each sampling moment.

The thermometer is configured to collect the stokes signals and the anti-stokes signals at a fixed working frequency, and the pair of signals collected every time are consistent in time, as shown in FIG. 5.

However, because a transmission speed, of the stokes signals is inconsistent with a transmission speed of the anti-stokes signals in the optical fiber, the pair of signals collected every time on the distance are not aligned, as shown in FIG. 6.

Therefore, in the above case, it is necessary to perform interpolation calculation on the stokes signals and the anti-stokes signals so as to obtain a pair of signals that is uniform in distance. That is, the data of the stokes signals is aligned with the data of the anti-stokes signal in distance.

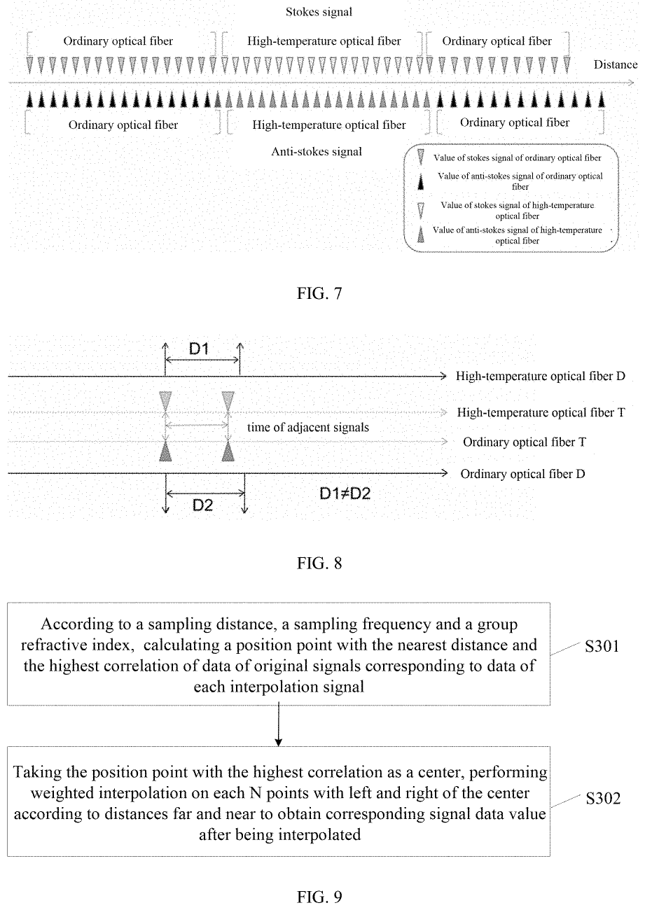

At the same time, for the ordinary optical fiber and the high-temperature optical fiber being welded together, their group refractive indexes of the ordinary and high-temperature optical fibers are inconsistent, a distance between every two adjacent signals in the high-temperature optical fiber is inconsistent with a distance between two every adjacent signals in the ordinary optical fiber, the distance between a pair of stokes and anti-stokes signals collected by the thermometer varies in different fiber segments, as shown in FIG. 7 and FIG. 8. Thus, interpolation calculation is performed on the data collected by ordinary and high-temperature optical fibers, respectively.

Specifically, referring to FIG. 9, the interpolation calculation includes the following steps:

S301, According to a sampling distance, a sampling frequency and a group refractive index, calculating a position point with the nearest distance and the highest correlation that data of original signals corresponding to data of each interpolation signal, according to the formula below:

$$X = \frac{D * Ng}{C} * F {s}_{;}$$

wherein X is a position point with the highest correlation; D is a sampling distance; Ng is a group refractive index of optical fibers; C is a velocity of light in a vacuum; Fs is a sampling frequency.

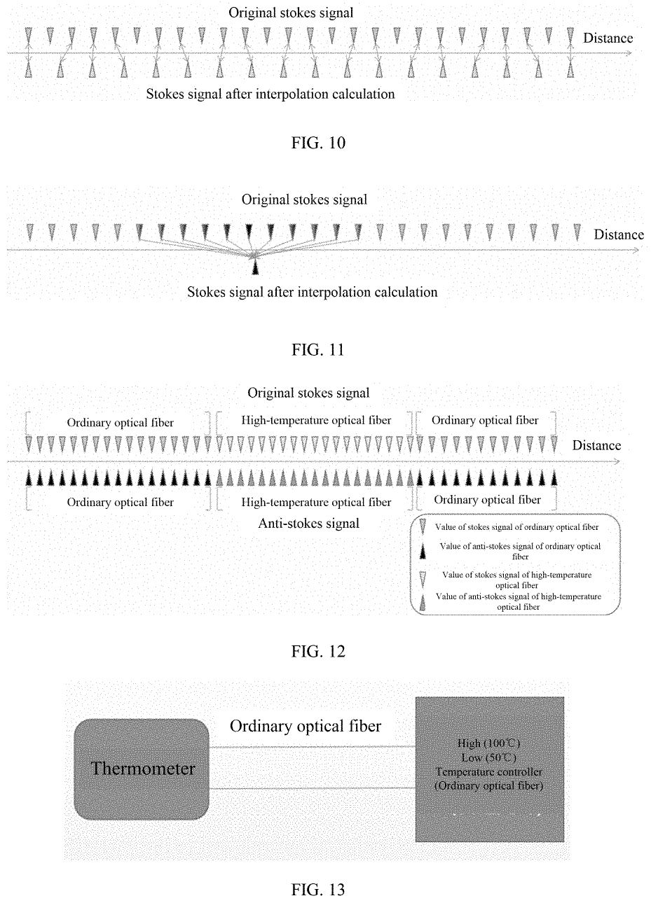

Referring to FIG. 10, an upper row is original stoker signals, and a lower row tis a target position to be inserted. When inserting the target position, it is necessary to find the point X with the highest correlation from the original signals in the upper row.

S302, taking the position point with the highest correlation as a center, performing weighted interpolation on each N points with left and right of the center according to distances far and near to obtain a corresponding value of signal data after being interpolated.

After finding the point with the highest correlation from the step S301, performing weighted interpolation on each N points with left and right of the center according to distances far and near to obtain a corresponding value of signal data after being interpolated. For example, calculating the intensity of the stokes optical signals after the stokes optical signals are interpolated. As shown in FIG. 11, it is intended to insert a stokes signal at the target position in the lower row. After the point with the highest correlation is selected in the upper row, taking the point with the highest correlation as a center, signal strength of each 5 points on the left and right is performed weighted interpolation calculation to obtain a value of the signal strength that the signal is inserted at the target position.

Itis assumed that the center of the upper row and the 5 points on the left and right are: X, X−1, X+1, X−2, X+2, X−3, X+3, X−4, X+4, X−5, X+5;

stokes signal intensity of the eleven points respectively are: P(X), P(X−1), P(X+1), P(X−2), P(X+2), P(X−3), P(X+3), P(X−4), P(X+4) P(X−5), P(X+5).

According to the distance, inverse distance weights are assigned, wherein a weight of P(X) is 0.6, both weights of P(X−1) and P(X+1) are 0.1, both weights of P(X−2) and P(X+2) are 0.1, both weights of P(X−3) and P(X+3) are 0.1, both weights of P(X−4) and P(X+4) are 0.05, and both weights of P(X−5) and P(X+5) are 0.05.

Then, the numerical calculation results of the target position being performed interpolation calculation are:

P(Ins)=P(X)*0.6+P(X−1)*0.1+P(X+1)*0.1+P(X−2)*0.1+P(X+2)*0.1+P(X−3)*0.1+P(X+3)*0.1+P(X−4)*0.05+P(X+4)*0.05+P(X−5)*0.05+P(X+5)*0.05.

Finally, the optical signals collected by the high-temperature optical fiber and the ordinary optical fiber are aligned in distance to ensure accuracy of subsequent temperature measurements, as shown in FIG. 12.

S40, according to the data of the aligned stokes and anti-stokes signals, performing temperature data calculation on the data of the segment of the high-temperature optical fiber and the data of the segment of the ordinary optical fiber, respectively.

Performing temperature data calculation on, the aligned data of the optical signals after being performed interpolation calculation on the step S30, for example, calculating a ratio R of the data of the anti-stokes signals and the data of the stokes signals, the ratio R of the data of the anti-stokes signals and the data of the stokes signals is correlated with temperatures, so it can be used as temperature data to provide parameters for the final temperature calculation.

S50, separately connecting the segment of the ordinary optical fiber and the segment of the high-temperature optical fiber with a distributed fiber thermometer and a high-an-low temperature controller, so as to obtain calibration parameters of the ordinary optical fiber and the high-temperature optical fiber, respectively.

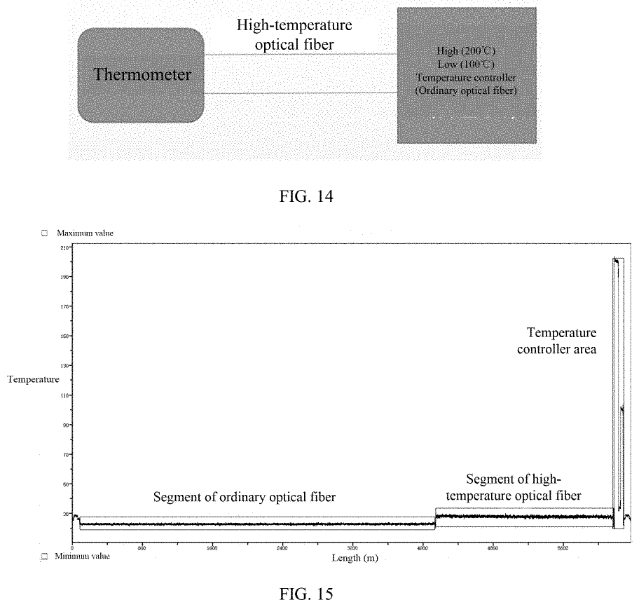

Referring to FIG. 13 and FIG. 14, the ordinary optical fiber and the high-temperature optical fiber are connected with the distributed optical fiber thermometer and the high-and-low temperature controller, respectively, so that the calibration parameters of the ordinary optical fiber and the high-temperature optical fiber can be obtained by using a temperature difference by measuring high and low temperatures.

Specifically, the calibration parameters include a temperature proportional coefficient adjustment parameter A and an offset compensation parameter B obtained under a temperature difference between a high temperature and a low temperature set in the high-and-low temperature controller for each optical fiber.

Only when measured values of the parameter A and the parameter 13 are different for optical fibers with different materials can be the same temperature value that is measured for different optical fibers in the same environment.

In an embodiment of the present disclosure, the parameter A is determined by the difference between a position with 100° C. and a position with 200° C. of the optical fiber in the high-and-low temperature controller. For example, a low temperature position and a high temperature position in the high-and-low temperature controller are preset at 100° C. and 200° C., respectively. Before the parameters A and B are adjusted and calibrated, an actual measurement temperature of the low-temperature position of the optical fiber in the high-and-low temperature controller is 95° C., and an actual measurement temperature of the high-temperature position is 205° C., with a difference of 110° C. being formed therebetween, which is obviously inconsistent with a preset difference.

At this time, adjusting the parameter A, for example, when the parameter A is 500, an actual measured temperature difference of the optical fiber in the temperature controller is adjusted to 100° C., for example, the low temperature position is 98° C., and the high temperature position is 198° C., at this time, adjusting the parameter B, for example, the parameter B is set as 2, then the actual measurement temperature at the low temperature position is 100° C., and the actual measurement temperature at the high temperature position is 200, and the difference value is also the preset 100° C. so the measured value is consistent with the preset value to meet measurement requirements. At this time, the values of the parameters A and B are the calibration parameters of the optical fiber.

For an, acrylate coated optical fiber (Acrylate fiber), the parameters A and B are A=630 and B=−0.5, by connecting the Acrylate fiber with the distributed optical fiber thermometer and the high-and-low temperature controller to measure the parameters A and B.

S60, generating a final temperature according to the temperature data of the segment of the high-temperature optical fiber and the temperature data of the segment of the ordinary optical fiber, and their corresponding calibration parameters.

Specifically, the final temperature is generated by a formula below:

T(A*R+B)−273.15;

wherein T is a final temperature, which is a Celsius temperature; R is the temperature data calculated in the step S40, and the temperature data is a ratio of the data of the anti-stokes signal to the data of the stokes signal.

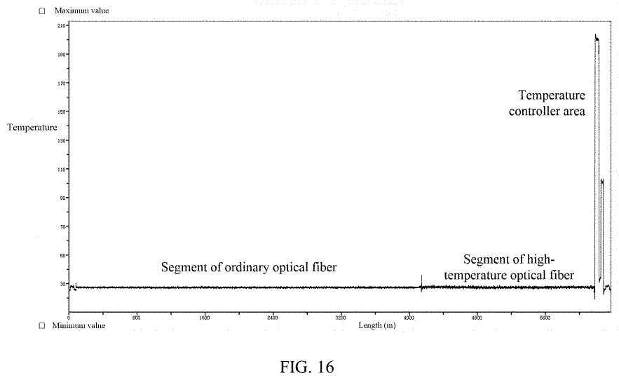

Referring to FIG. 15 and FIG. 16, FIG. 15 is shown the final temperature curve of the un-calibrated optical fiber, it can be obviously observed that when the actual measurement environment is the same temperature, the temperature measured at the junction between the segment of the ordinary optical fiber and the segment of the high-temperature optical fiber is inconsistent and there is a mutation, so that the temperature measured by the optical fiber is not accurate.

FIG. 16 is shown the final temperature curve of the fiber after being calibrated, it can be obviously observed that when the actual measurement environment is the same temperature, the temperature measured at the junction between the segment of the ordinary optical fiber and the segment of the high-temperature optical fiber is consistent, so that the measured temperature of the whole fiber can accurately reflect the actual temperature.

The temperature measuring method of distributed multi-section optical fibers of the present disclosure is configured to divide an optical fiber into at, least one high-temperature optical fiber and at least one ordinary optical fiber interlaced to connect with each other, distinguish data of the segment of the high-temperature optical fiber and data of the segment of the ordinary optical fiber during temperature measurement, and perform interpolation calculation on the data of the segment of the high-temperature optical fiber and the data of the segment of the ordinary optical fiber, respectively, according to their respective corresponding group refractive indexes, to align the data of the stokes signals with the data of the anti-stokes signal in distance at each sampling moment and generate a final temperature by combining different calibration parameters of the high-temperature optical fiber and the ordinary optical fiber, respectively. In this way, the present disclosure can not only reduce costs of the temperature measuring system of distributed multi-section optical fibers under high temperature environments, but also eliminate measurement deviation between the high-temperature optical fibers and the ordinary optical fibers to ensure measurement accuracy of the temperature measuring system of distributed multi-section optical fibers.

A system 100 according to an embodiment of distributed multi-section optical fibers of the present disclosure includes a memory, a processor and computer programs stored in the memory and performed by the processor to implement the temperature measuring method above mentioned.

Referring to FIG. 1, the system 100 of the present disclosure includes a distributed optical fiber thermometer 1 and an optical fiber with multiple segments 2, the optical fiber with multiple segments 2 divided into a high-temperature optical fiber 21 and two ordinary optical fibers interlaced connected with the high-temperature optical fiber 21. The distributed optical fiber thermometer 1 includes a pair of ports 11, 12 respectively connected to corresponding ends of the two ordinary optical fibers 22, the other ends of the two ordinary optical fibers 22 respectively connected with the high-temperature optical fiber 21. The system 100 further includes a temperature controller 3 that is a high-and-low temperature controller, which is used to provide a high temperature and a low temperature with differences for optical fibers.

The distributed optical fiber thermometer 1 can be configured to provide a memory, a processor, and computer programs stored in the memory and performed by the processor, or the distributed optical fiber thermometer 1 can be connected to an external computer on which a memory, a processor and a computer program stored in the memory and performed by the processor are arranged.

Exemplary, the computer programs can be segmented into one or more modules/units that are stored in the memory and performed by the processor, to implement the temperature measuring method of distributed multi-section optical fibers of the present disclosure. The one or more modules/units may be a series of computer program instruction segments capable of performing a specific function, which are used to describe execution of the computer program in asynchronous message processing terminal devices.

The system can include, but not limited the processor and the memory. One of ordinary skill in the related art can understand that the above components are only examples based on the system and do not constitute a qualification to the system, which can include more or fewer components than the components described above, or some combination of components, or different components. For example, the system can also include input/output devices, network access devices, buses, and so on.

The Processor can be a central, processing unit (CPU), or other general-purpose processors, digital signal processors (Digital Signal Processor (DSPs), Application Specific Integrated Circuits (ASICs), field-Programmable Gate Arrays (FPGAs), FPGAs or other programmable logic devices, discrete gates or transistor logic devices, discrete hardware components, etc. The general-purpose processor can be a microprocessor or the processor can be any general processors, etc. The processor is a control center of the device and connected to various parts of the entire system by various interfaces and lines.

The memory can be configured to store the computer program and/or modules, and the processor is configured to realize various functions of the device by running or executing the computer program and/or modules stored in the memory, and by calling data stored in the memory. The memory can mainly include a storage program area and a storage data area, wherein the storage program area is configured to store applications required by operating systems and at least one function (such as a sound playing function, an image playing function, etc.); the storage data area is configured to store data created based on usages (such as audio data, phone book, etc.), and so on. In addition, the memory can include a high speed random access memory, also include a non-volatile memory such as a hard disk, a internal storage, a plug-in hard disk, a smart media card (SMC), a secure digital (Si)) card, a flash card, at least one disk storage device, a flash memory device, or other volatile solid state storage devices.

The temperature measuring method of distributed multi-section optical fibers and the system of the present disclosure have the following beneficial effects:

1. applications of different kinds of optical fibers in distributed optical fiber temperature sensors;

2. applications of an optical fiber segmentation method and a system when different kinds of fiber are used together;

3. applications of different kinds of optical fibers in the configuration of optical group refractive indexes in segmented fibers;

4. calibration and configuration application of temperature calibration parameters of different kinds of fibers in segmented fibers;

5. the temperature measuring method of distributed multi-section optical fibers and the system are not limited to two segments and three segments of optical fibers, but can be mixed with N segments of optical fibers.

6. the temperature measuring method of distributed multi-section optical fibers and the system are not limited to applications of distributed fiber temperature sensors in the field of oil well measurement, but can be widely used in other fields, such as fire protections, chemical industries, pipelines and others.

7. the temperature measuring method of distributed multi-section optical fibers and the system are not limited to distributed optical fiber temperature sensors, but can also be applied to other distributed sensors, such as stress, vibration and other types of distributed optical fiber sensors.

8. the temperature measuring method of distributed multi-section optical fibers and the system are not limited to distributed optical fiber temperature sensors with two ports, but also can be applied to distributed optical fiber temperature sensors with a single port.

A computer readable storage medium according to an embodiment of the present disclosure can be configured to store computer programs, the computer programs performed by a processor to implement the temperature measuring method above mentioned.

The temperature measuring method of distributed multi-section optical fibers of the present disclosure is integrated with modules/units that can be stored in a computer-readable storage medium if implemented as software functional units and sold or used as stand-alone products. A specific embodiment of the computer readable storage medium is basically the same as embodiments of the temperature measuring method of distributed multi-section optical fibers mentioned above, which will not be repeated here.

It should be noted that the embodiments described above are only schematic examples, the units described as detached parts can or can't be physically separated, and the components displayed as units can or can't be physical units, that is, they can be located in one place, or they can be distributed over multiple network units. Some or all of the modules can be selected according to actual needs to achieve the purpose of the scheme of embodiments. In addition, in the accompanying drawings provided in embodiments of the present disclosure, a connection relation between the modules is indicated that a communication connection is formed between the modules, which can be specifically realized as one or more communication buses or signal lines. One of ordinary skill in the related art on the premise of no creative work can understand and implement the method above mentioned.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A temperature measuring method of distributed multi-section optical fibers applied to a temperature measuring system of distributed multi-section optical fibers, the temperature measuring system comprising a distributed optical fiber thermometer and an optical fiber with multiple segments, the optical fiber with multiple segments divided into at least one high-temperature optical fiber and at least one ordinary optical fiber interlaced to be connected with the at least one high-temperature optical fiber, the method comprising the following steps:
S10, obtaining data of original stokes signals and data of anti-stokes signals in a while optical fiber;
S20, distinguishing data of a segment of a high-temperature optical fiber and data of a segment of an ordinary optical fiber according to a discontinuous point of signal data;
S30, performing interpolation calculation on the data of the segment of the high-temperature optical fiber and the data of the segment of the ordinary optical fiber, respectively, according to their respective corresponding group refractive indexes, to align the data of the stokes signals with the data of the anti-stokes signal in distance at each sampling moment;
S40, according to the data of the aligned stokes and anti-stokes signals, performing temperature data calculation on the data of the segment of the high-temperature optical fiber and the data of the segment of the ordinary optical fiber, respectively;
S50, separately connecting the segment of the ordinary optical fiber and the segment of the high-temperature optical fiber with a distributed fiber thermometer and a high-an-low temperature controller, so as to obtain calibration parameters of the ordinary optical fiber and the high-temperature optical fiber, respectively;
S60, generating a final temperature according to temperature data of the segment of the high-temperature optical fiber and the segment of the temperature data of the ordinary optical fiber, and their corresponding calibration parameters.

2. The temperature measuring method as claimed in claim 1, wherein the interpolation calculation comprises the following steps:
S301, according to a sampling distance, a sampling frequency and a group refractive index, calculating a position point with the nearest distance and the highest correlation that data of original signals corresponding to data of each interpolation signal, according to the formula below;
$$X = \frac{D * Ng}{C} * Fs ;$$
wherein X is a position point with the highest correlation; D is a sampling distance; Ng is a group refractive index of optical fibers; C is a velocity of light in a vacuum; Fs is a sampling frequency;
S302, taking the position point with the highest correlation as a center, performing weighted interpolation on each N points with left and right of the center according to distances far and near to obtain a corresponding value of signal data after being interpolated.

3. The temperature measuring method as claimed in claim 1, wherein the calibration parameters comprise a temperature proportional coefficient adjustment parameter A and an offset compensation parameter B obtained under a temperature difference between a high temperature and a low temperature set in the high-and-low temperature controller for each optical fiber.

4. The temperature measuring method as claimed in claim 3, wherein the final temperature is generated by a formula below:
T=(A*R+B)−273.15;
wherein T is a final temperature; R is the temperature data calculated in the step S40, and the temperature data is a ratio of the data of the anti-stokes signal to the data of the stokes signal.

5. A system comprising a distributed optical fiber thermometer and an optical fiber with multiple segments, the optical fiber with multiple segments divided into at least one high-temperature optical fiber and at least one ordinary optical fiber interlaced to be connected with the at least one high-temperature optical fiber, the system further comprising a memory, a processor and computer programs stored in the memory and performed by the processor to implement a temperature measuring method; the method comprising the following steps:
S10, obtaining data of original stokes signals and data of anti-stokes signals in a while optical fiber;
S20, distinguishing data of a segment of a high-temperature optical fiber and data of a segment of an ordinary optical fiber according to a discontinuous point of signal data;
S30, performing interpolation calculation on the data of the segment of the high-temperature optical fiber and the data of the segment of the ordinary optical fiber, respectively, according to their respective corresponding group refractive indexes, to align the data of the stokes signals with the data of the anti-stokes signal in distance at each sampling moment;
S40, according to the data of the aligned stokes and anti-stokes signals, performing temperature data calculation on the data of the segment of the high-temperature optical fiber and the data of the segment of the ordinary optical fiber, respectively;
S50, separately connecting the segment of the ordinary optical fiber and the segment of the high-temperature optical fiber with a distributed fiber thermometer and a high-an-low temperature controller, so as to obtain calibration parameters of the ordinary optical fiber and the high-temperature optical fiber, respectively;
S60, generating a final temperature according to temperature data of the segment of the high-temperature optical fiber and the segment of the temperature data of the ordinary optical fiber, and their corresponding calibration parameters.

6. The system as claimed in claim 5, wherein the distributed optical fiber thermometer comprises a pair of ports respectively connected to corresponding ends of the two ordinary optical fibers, the other ends of the two ordinary optical fibers respectively connected with the high-temperature optical fiber.

7. The system as claimed in claim 6, wherein the ordinary optical fiber is connected with the high-temperature optical fiber by a welding, connection way.

8. The system as claimed in claim 5, wherein the interpolation calculation comprises the following steps:
S301, according to a sampling distance, a sampling frequency and a group refractive index, calculating a position point with the nearest distance and the highest correlation that data of original signals corresponding to data of each interpolation signal, according to the formula below:
$$X = \frac{D * Ng}{C} * Fs ;$$
wherein X is a position point with the highest correlation; D is a sampling distance; Ng is a group refractive index of optical fibers; C is a velocity of light in a vacuum; Fs is a sampling frequency;
S302, taking the position point with the highest correlation as a center, performing weighted interpolation on each N points with left and right of the center according to distances far and near to obtain a corresponding value of signal data after being interpolated.

9. The system as claimed in claim 5, wherein the calibration parameters comprise a temperature proportional coefficient adjustment parameter A and an offset compensation parameter B obtained under a temperature difference between a high temperature and a low temperature set in the high-and-low temperature controller for each optical fiber.

10. The system as claimed in claim 9, wherein the final temperature is generated by a formula below:
T=(A*R+B)−273.15;
wherein T is a final temperature; R is the temperature data calculated in the step S40, and the temperature data is a ratio of the data of the anti-stokes signal to the data of the stokes signal.

11. A computer readable storage medium configured to store computer programs, the computer programs performed by a processor to implement a temperature measuring method applied to a temperature measuring system of distributed multi-section optical fibers, the temperature measuring system comprising a distributed optical fiber thermometer and a optical fiber with multiple segments, the optical fiber with multiple segments divided into at least one high-temperature optical fiber and at least one ordinary optical fiber interlaced connected with the at least one high-temperature optical fiber, the method comprising the following steps:
S10, obtaining data of original stokes signals and data of anti-stokes signals in a while optical fiber;
S20, distinguishing data of a segment of a high-temperature optical fiber and data of a segment of an ordinary optical fiber according to a discontinuous point of signal data;
S30, performing interpolation calculation on the data of the segment of the high-temperature optical fiber and the data of the segment of the ordinary optical fiber, respectively, according to their respective corresponding group refractive indexes, to align the data of the stokes signals with the data of the anti-stokes signal in distance at each sampling moment;
S40, according to the data of the aligned stokes and anti-stokes signals, performing temperature data calculation on the data of the segment of the high-temperature optical fiber and the data of the segment of the ordinary optical fiber, respectively;
S50, separately connecting the segment of the ordinary optical fiber and the segment of the high-temperature optical fiber with a distributed fiber thermometer and a high-an-low temperature controller, so as to obtain calibration parameters of the ordinary optical fiber and the high-temperature optical fiber, respectively;
S60, generating a final temperature according to temperature data of the segment of the high-temperature optical fiber and the segment of the temperature data of the ordinary optical fiber, and their corresponding calibration parameters.
